(19) United States
(12) Patent Application Publication
(10) Pub. No.: US 2008/0129059 A1
(43) Pub. Date: Jun. 5, 2008

(54) LC Oscillation-Based Magnetic Lock

(76) Inventor: Chen-Fei Chang, Taipei City (TW)

Correspondence Address: LIN & ASSOCIATES INTELLECTUAL PROPERTY, INC., P.O. BOX 2339, SARATOGA, CA, 95070-0339, US

(21) Appl. No.: 11/566,209

(22) Filed: Dec. 2, 2006

(51) Int. Cl. E05B 47/00

(52) U.S. Cl. 292/251.5

(57) ABSTRACT

An LC oscillation-based magnetic lock is described, which mainly includes an electromagnet set having an E-type iron core and a magnetic field generating coil set, and an armature plate. The electromagnet set and the armature plate are installed on a door panel and a door jamb, respectively. By means of the attractive or repelling force between the aforementioned each other, and by controlling the magnetism of the electromagnet set, the door panel is caused to be opened or closed. The LC oscillation-based circuit being a coil set disposed nearby the magnetic field generating coil set and oscillating in an oscillation frequency when an inductance variation has occurred, the oscillation frequency is then corresponded to the inductance variation; and a control circuit is to determine an open/close state of the door panel according to the oscillation frequency calculated.

### BACKGROUND OF THE INVENTION

1. Field of the Invention

The present invention relates to a magnetic lock, and particularly to an LC oscillation-based magnetic lock.

2. The Prior Arts

A magnetic lock may be used as a lock installed on an object requiring to be protected with a lock, particularly a door. The magnetic lock is mainly composed of an electromagnet set and an armature plate. The electromagnet set is comprised of an E-type iron core and a magnetic field generating coil set. Specifically, when used on a door, the electromagnet set and the armature plate are installed on the door stile of the door panel, and on a door jamb provided along the vertical portion of the door frame, respectively. By controlling the magnetism of the electromagnet set, the electromagnet set and the armature plate are caused to attract or repel each other. In this manner, the door can be locked and unlocked.

Generally, a door state can be detected by two types of the magnetic lock: the magnetic reed switch type and the magnetic sensing Hall IC type. The reed switch is a device having a reed tube as the main housing for transforming a mechanical act into an electric signal. The reed tube is composed of two contact blades with low-hysteresis disposed in parallel with each other, and having an overlapping portion formed at a tail end thereof and thereby forming a gap. Each of the two thin and long contact blades contains 50% nickel and 50% iron, and a noble metal layer is coated thereon. The noble metal layer is coated to assure the contact blades of having optimal performance. The noble metal is typically rhodium, ruthenium, and gold.

The two contact blades are totally enclosed in a glass tube having an inert gas therein. When a magnetic field is brought into proximity, an opposite polarity is induced on each of the two contact blades at the overlapping portion, respectively. When the polarities are large enough, the two contact blades are attracted to each other and forming a connection therebetween. The reed tube possesses no mechanical components; therefore, would not result in being stuck or locked up, or any other breakdowns. This aforementioned unobstructed operation can be precisely and very rapidly performed and repeated up to millions of times. When a permanent magnet is moved near or away from the reed tube, the reed tube is thereby caused to perform switching operation, for opening and closing of the door using the magnetic lock.

In the actual application of the reed switch with respect to the magnetic lock, the armature plate corresponding to the E-type silicon steel sheet core is drilled to form a hole and a permanent magnet is filled therein. At a position opposite to the permanent magnet, i.e. at the E-type silicon steel sheet core, the reed switch is disposed to induce a magnetic force of the permanent magnet. When the E-type silicon steel sheet core is contacted with the armature plate, the reed switch is opened. On the other hand, when the E-type silicon steel sheet core is separated from the armature plate, no magnetic force is induced, and resulting in a close circuit of the reed switch. However, the above mentioned glass tube is typically used to enclose the open/close contact point in a commercially-available reed switch, causing the glass tube to be susceptible to be shattered when a violent vibration has occurred. Further, the open/close contact point is vulnerable to oxidation when it has been used for an extended period of time, and resulting in having a bad contact with respect to the open/close contact point.

Hall IC is a product in which the Hall device and the electronic circuits are integrated together. Specifically, the Hall IC is obtained by incorporating the Hall device, amplifiers, temperature compensating circuit, and voltage regulating circuit under the conventional semiconductor fabrication process. Any physical quantity associated with magnetism can be sensed by the Hall IC. Further, the Hall IC is able to output electrical control information in response to the corresponding sensed physical quantity. In fact, the Hall IC is a magnetic sensor in the form of an IC. Generally, the Hall IC is presented in a dual in-line package (DIP) or a flat package.

In the actual application of the Hall IC in magnetic lock, a trench is formed on the E-type silicon steel sheet core, and the Hall IC is filled therein with a hot melt glue subsequently added thereon to fill up the trench. When the armature plate is closed, it happens to be that a magnetic loop is formed on the silicon steel sheet core, in which a huge amounts of magnetic lines are flowed through the silicon steel sheet core, and thereby resulting in a close circuit of the Hall IC since the magnetic lines are also flowed through the Hall IC.

When the armature plate is opened or separated, the Hall IC has then become an open circuit, since the magnetic lines are thereby dispersed due to the absence of the magnetic loop. However, since the Hall IC has to be buried into the E-type silicon steel sheet core and to be fixed thereon by using glue, more labor therefore is required, and thus the maintenance required is also troublesome.

### SUMMARY OF THE INVENTION

It is, therefore, an object of the present invention to provide an LC oscillation-based magnetic lock, by the use of calculating an oscillation frequency in accordance with to an inductance variation caused by the door being opened or closed, thus the open/close state of the door is determined according to the corresponding inductance variation. In this manner, the LC oscillation-based magnetic lock is of simpler manufacturing of process and is thus eliminated from oxidation of the contact point.

In accordance with the above object, the LC oscillation-based magnetic lock is mainly comprised of an electromagnet set including an E-type core and a magnetic field generating coil set, and an armature plate. Due to the LC oscillation circuit being a coil set disposed nearby the magnetic field generating coil set, therefore, the change in inductance caused by the door panel at a close state, thereby leads to the LC oscillation circuit to be oscillating in a corresponding oscillation frequency. As a result, it is only required to calculate the oscillation frequency corresponding to the inductance variation for determining the open/close state of the door.

Other advantages and efficacies of the present invention may be further appreciated after the description below with reference to the annexed drawings is read.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1A is a block diagram of an LC oscillation-based magnetic lock according to the present invention; and

FIG. 1B is a circuit diagram of the LC oscillation-based magnetic lock according to the present invention.

### DETAILED DESCRIPTION OF THE PREFERRED EMBODIMENT

The present invention will be described in detail with reference to the drawings.

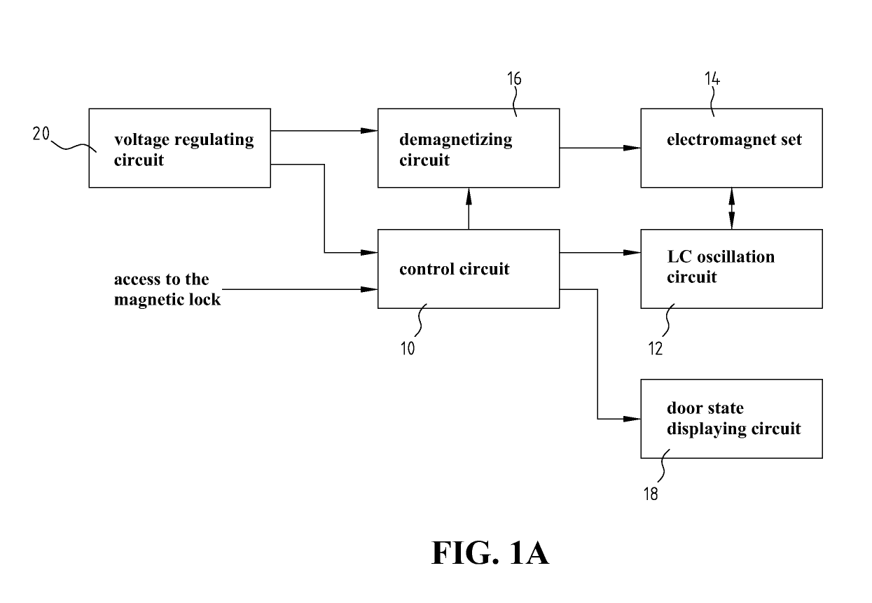

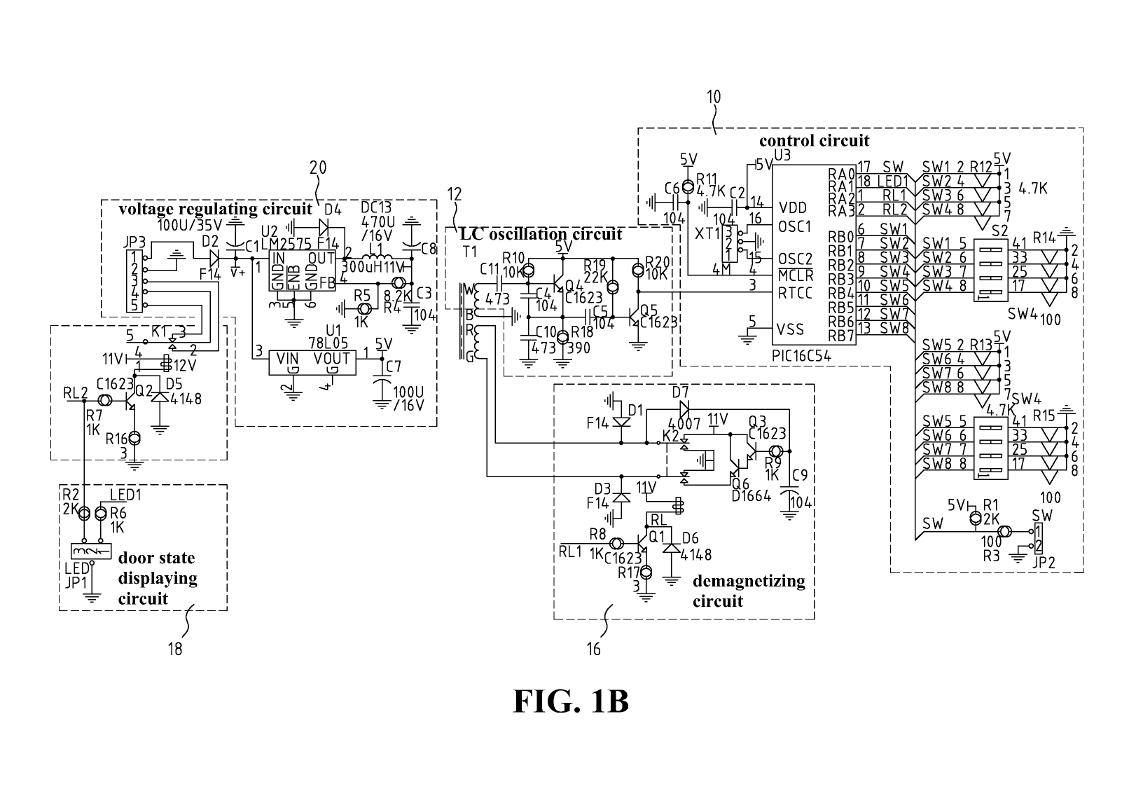

Referring to FIGS. 1A and 1B, a block diagram and a circuit diagram of an LC oscillation-based magnetic lock according to the present invention are depicted therein, respectively. As shown in FIG. 1A, the LC oscillation-based magnetic lock mainly comprises an electromagnet set 14, an armature plate (not shown), an LC oscillation circuit 12, and a control circuit 10. The electromagnet set 14 further comprises an E-type iron core and a magnetic field generating coil set. Referring to FIG 1B, the circuit design of the LC oscillation-based magnetic lock is provided.

Generally, the electromagnet set 14 and the armature plate of the magnetic lock are installed on a door panel (not shown) and a doorjamb (not shown). By means of the attractive or repelling force between the electromagnet set 14 and the armature plate, the magnetic lock is made to be in a lock or unlock state. In other words, when the control circuit 10 has received the signal to launch the unlock state of the magnetic lock, the change in magnetic force caused by the electromagnet to achieve the objective of opening and closing the door.

To detect the open/close state of the door panel, a coil set, whose coil number is to be less than that of the magnetic field generating coil, is disposed at a position nearby the magnetic field generating coil set. When the door panel is closed, an inductance variation is to occur, thus causing the LC oscillation circuit 12 to oscillate in an oscillation frequency corresponding thereto. At this time, the control circuit 10 is able to determine the open/close state of the door according to the oscillation frequency of the LC oscillation circuit 12. As compared to the conventional reed switch or the Hall IC type magnetic lock, the LC oscillation-based magnetic lock of the present invention is relatively simpler for manufacture since it can do without the steps of mechanical slicing, drilling of holes, and glue filling that are typically used in the prior art. In addition, the issue of oxidation of the contact point found in the prior art does not exist in the present invention.

In the magnetic lock, a magnetization effect is often found on the magnetic lock by means of a remaining magnetic field left when the magnetic lock is locked for an extended period of time. This remaining magnetism can cause the door to be difficult to be opened. To solve this problem, a demagnetizing circuit 16 is additionally provided, as illustrated in FIG. 1A, in addition to the electromagnet set 14, the armature plate (not shown), the LC oscillation circuit 12, and the control circuit 10.

It only requires a relay and a Darlington RC charge/discharge circuit to be able to form the demagnetizing circuit 16. When the door is to be opened and thus unlocked, the current flown in the magnetic lock is open-circuited. After the current in the magnetic lock is open-circuited, a short duration voltage in the opposite direction is provided to the magnetic lock through the demagnetizing circuit 16. At this time, an opposite magnetic field is to occur on the magnetic lock and the remaining magnetic field is thus eliminated. Accordingly, a user can then easily unlock the door even after an extended time period of locked state of the magnetic lock.

In addition, to enable the user to know the current open/close state of the door, a door state signal may be issued from the control circuit 10 to a door state displaying circuit 18. A light signal may be provided and controlled by the door state displaying circuit 18 so that the open/close state of the door can be obtained by the user. The voltage regulating circuit 20 is used to provide for the power source for the operation of the magnetic lock.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. An LC oscillation-based magnetic lock, comprising:
an electromagnet set wherein comprising an E-type iron core and a magnetic field generating coil set; and
an armature plate, wherein the electromagnet set and the armature plate are installed on a door panel and a door jamb, respectively, and controlling the magnetism of the electromagnet set for making the electromagnet set and the armature plate to be attracted or repelled with each other for causing the door panel to be opened or closed, and the LC oscillation-based magnetic lock, comprising:
an LC oscillation circuit, being a coil set disposed nearby the magnetic field generating coil set, and oscillating at an oscillation frequency at the occurring of an inductance variation, wherein the oscillation frequency is corresponded to the inductance variation; and
a control circuit, determining an open/close state of the door panel according to the oscillation frequency to be calculated.

2. The LC oscillation-based magnetic lock as claimed in claim 1, wherein a demagnetizing circuit is electrically coupled to the magnetic field generating coil for eliminating the remaining portion of magnetism on the magnetic field generating coil, thereby unlocking the door panel.
